(19) United States
(12) Patent Application Publication
(10) Pub. No.: US 2016/0332059 A1
(43) Pub. Date: Nov. 17, 2016

(54) DISPLAY, METHOD AND COMPUTER PROGRAM

(71) Applicants: Sony Corporation, Tokyo (JP); Sony Europe Limited, Weybridge (GB)

(72) Inventor: Tony Emmanuel Ramin SEEFF, Edgeware (GB)

(73) Assignees: Sony Corporation, Tokyo (JP); Sony Europe Limited, Weybridge (GB)

(21) Appl. No.: 15/045,572

(22) Filed: Feb. 17, 2016

(30) Foreign Application Priority Data
May 15, 2015 (GB) 1508378.5

(51) Int. Cl. A63C 11/00; G06T 11/60; G02B 27/01

(52) U.S. Cl. CPC A63C 11/003; G02B 27/017; G06T 11/60; G02B 2027/014; G02B 2027/0141; G02B 2027/0138

(57) ABSTRACT

A snow-sport head mounted display device for a user is described. The display device comprising: an augmented reality display and processing circuitry configured to provide augmented reality information to the augmented reality display, wherein the processing circuitry is configured to receive an image of the real-world, identify at least one real-world obstacle in the image, and display, on the augmented reality display, an appropriate path for travel on the basis of the at least one identified obstacles.

### CROSS REFERENCE TO RELATED APPLICATIONS

The present application claims priority to United Kingdom Application GB1508378.5 filed on 15 May 2015, the contents of which being incorporated herein by reference in its entirety.

### BACKGROUND

The present disclosure relates, in general but not exclusively to, a display supporting augmented reality.

### BACKGROUND TO THE DISCLOSURE

When skiing or snowboarding it is common that many people are on the slopes at the same time. These people have different abilities and so will overtake one another as they traverse the mountain. Other wintersports enthusiasts are only one obstacle on the slopes. Other obstacles may include ice patches that form during the night and/or day. In addition to these obstacles, the slopes have other stationary obstacles such as steep drops, safety fencing and signage. Given the speed at which people may travel down the slopes, and the significant risk of harm that may be caused by a collision, there is a need for an early warning system for a user of the slopes so that they can avoid collision and thus injury. The disclosure aims to provide such an early warning system.

### SUMMARY

According to the present disclosure, there is provided a snow-sport head mounted display device for a user, the display device comprising: an augmented reality display and processing circuitry configured to provide augmented reality information to the augmented reality display, wherein the processing circuitry is configured to receive an image of the real-world, identify at least one real-world obstacle in the image, and display, on the augmented reality display, an appropriate path for travel on the basis of the at least one identified obstacles.

### BRIEF DESCRIPTION OF THE DRAWINGS

Embodiments of the present disclosure will be now be described by way of example only and with reference to the accompanying drawings, in which:

FIG. 1 shows a device according to embodiments of the present disclosure;

FIG. 2 shows a camera arrangement on a helmet according to the present disclosure;

FIG. 3A shows a view from a user without eyewear according to the present disclosure;

FIG. 3B shows a view from a user with eyewear according to the present disclosure;

FIG. 4 shows a flow chart explaining the identification of some obstacles according to embodiments;

FIG. 5 shows a flow chart explaining identification of other obstacles according to embodiments;

FIG. 6A-6C shows an overhead view of a user and a skier with no collision;

FIG. 7A-7C shows an overhead view of a user and a skier with a collision;

FIG. 8A and 8B shows an overhead view of a user and a skier where a collision is avoided according to the present technique

FIG. 9 shows a flow chart explaining the process to determine the warning

FIG. 10 shows a flow chart explaining the process to generate the direction arrow; and

FIG. 11A to 11C explains the determination of the relative angle in FIG. 9.

### DESCRIPTION OF THE EMBODIMENTS

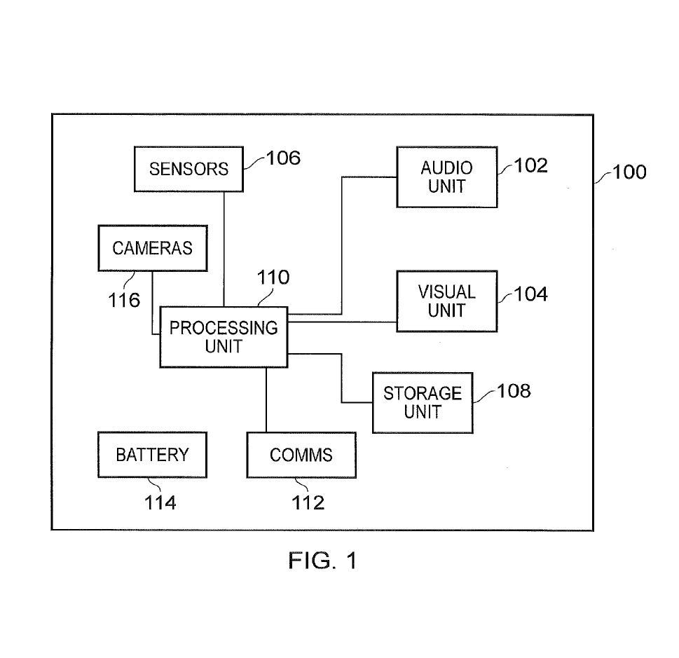

Referring to FIG. 1, a device 100 according to the present disclosure is shown. The device 100 includes a processing unit 110 that controls the operation of the device 100. The processing unit 110 is a microprocessor that includes circuitry. The processing unit 110 is controlled by software which includes computer code. The computer code is stored on memory that may be located within the processing unit 110. Alternatively, the computer code may be stored within the storage unit 108 located in the device 100 and also connected to the processing unit 110. The storage unit 108 (as well as any memory in the processing unit) will be memory which may be a magnetic or solid state type memory. This may be a removable storage device such as an SD card or may be integral to the device. The function of the storage unit 108 will be described later.

Additionally connected to the processing unit 110 is a communication unit 112. The communication unit 112 allows the device 100 to communicate with other devices either on a point-to-point basis or over a network. For example, the communication unit 112 may include a Bluetooth and/or WiFi unit which allows the device 100 to communicate with other devices using either the Bluetooth or WiFi Standards. Indeed, the communication unit 112 may also include cellular communication such as 3G or LTE or the like as would be appreciated. Moreover, and in addition, the communication unit 112 may include a Near-Field Communication unit that allows the device 100 to communicate with another NFC enabled device. Of course, these are examples of different types of wireless mechanisms that allows the device 100 to communicate with other devices. Other examples may allow the device 100 to be connected to other devices using a wired connection such as a USB or Fire Wire connection or the like.

Additionally connected to the e processing unit 110 is one or more sensor 106. The sensor or sensors may include gyroscopes, accelerometers, Global Positioning System (GPS), temperature sensors, barometer/altimeter, pressure sensors or the like. Additional sensors may include a vital sign sensor such as a heart rate monitor. Of course, although the device 100 may include these sensors, the sensors may be located in another device with which the device 100 communicates using the communication unit 112. For example, one or more of the sensors 106 may be located in a mobile (smart) telephone and the device 100 may retrieve the desired sensed information from the mobile telephone using the communication unit 112 using Bluetooth or the like. The functionality of the sensors 106 will be explained later.

A visual unit 104 is connected to the processing unit 110. The visual unit 104 provides a visual overlay on the goggles worn by the user. This is sometimes called “Augmented Reality” where a real life scene has computer generated data overlaid. The type of computer generated data and the mechanism by which the data is generated will be described later.

An audio unit 102 is also connected to the processing unit 110. The audio unit 102 typically controls a speaker. The speaker provides audible sounds to the user. The audible sound may be music or may be the sound from a smart phone. Alternatively, and in embodiments, the audible sound may be a warning sound such as an alarm or a warning sound as will be explained later.

The device 100 is powered by a battery 114. Of course, other forms of powering are envisaged such as solar powering or harnessing the energy from the user.

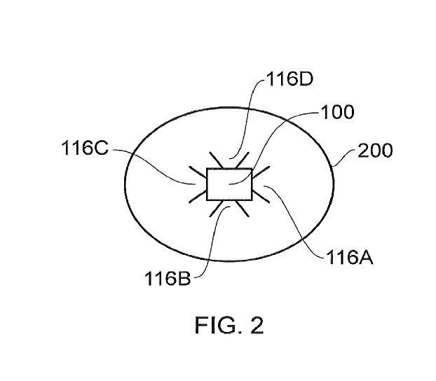

The device 100 according to embodiments is shown in FIG. 2 located atop a helmet 200. The device 100 may be integrated into the helmet 200 or may be attached to the helmet 200. If the device 100 is attached to the helmet 200, this may be achieved by a bespoke attaching mechanism (not shown) or may be attached using a press stud or the like. Additionally or alternatively, the device 100 may be attached using Velcro® or a suction cup. Also, although the above describes the device 100 being attached to a helmet 200, the disclosure is not so limited. For example, the device 100 could be attached to goggles or a piece of skiing apparel such as a ski jacket, ski pole, snow board or the like.

As is seen in FIG. 2, the device 100 has, in embodiments, four cameras 116A-116D included. These four cameras have different, but overlapping, fields of view. This ensures that the device 100 has a 360° view of the surroundings. In other words, the device 100 can see around the user. Of course, the disclosure is not limited to four cameras. It is possible that the device 100 has a single camera lens allowing a 360° field of view or may indeed have more than four cameras. Moreover, less than 360° is still envisaged if necessary. For example, the user may only wish the camera 116 to view in front and behind.

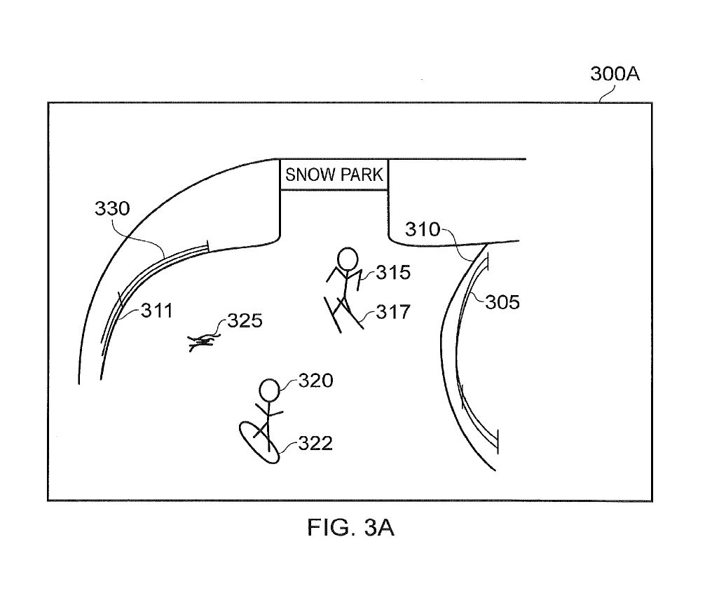

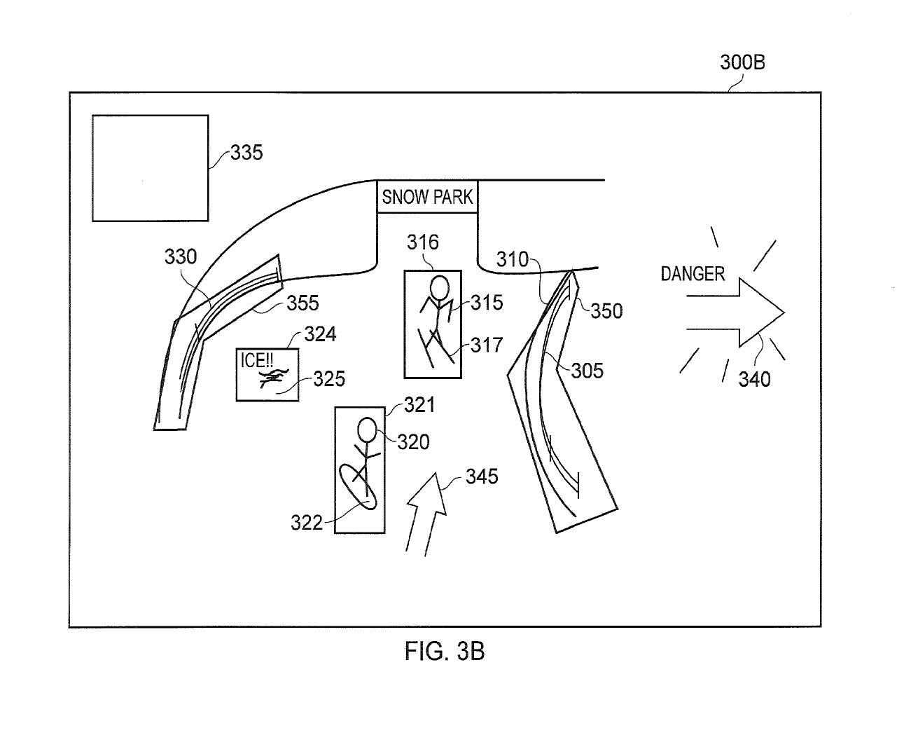

FIG. 3A shows a typical view for a user wearing conventional goggles. The user's view 300A is of a slope having a bridge with the sign “Snow Park” located thereon. The slope has a piste down which the user skis. At each side of the piste is an off-piste area. The off-piste area is defined by edge 311 and 310. The off-piste area is cordoned with barrier 305 and 330. This confines the skiers to the piste and ensures that the skiers do not ski off-piste. The barriers typically are made of flexible plastic and are brightly coloured.

Additionally located on the slope is a skier 315 wearing skis 317 and a snowboarder 320 wearing a snowboard 322. Additionally located on the slope is a patch of ice 325. Ice can be hazardous to skiers and snowboarders and can cause skiers and snowboarders to lose control and fall.

FIG. 3B shows a typical view 300B of a user wearing goggles or a device according to the present disclosure. FIG. 3B therefore shows the eyewear according to the disclosure. FIG. 3B shows the scene of FIG. 3A with the augmented information provided by the visual unit 104 included. Where the reference numerals refer to similar features, the reader is directed to the disclosure of FIG. 3A. As can be seen in FIG. 3B, the obstacles noted in FIG. 3A are highlighted in the view of FIG. 3B. In particular, skier 315 is identified in the image and a skier surround 316 is provided. The skier surround 316 is a box that is, typically, a bright colour. The purpose of skier surround 316 is to highlight the skier 315 to the user. In this regard, therefore, the skier surround 316 may flash or blink or in some way highlight the skier 315 to the user. Similarly, a snowboarder surround 321 is provided that highlights to the user the location of the snowboarder 320. It should be noted here that as the position of the skier and/or snowboarder changes in the view of the user, the skier surround 316 and/or the snowboarder surround 321 moves with the skier and/or snowboarder.

Additionally provided is a barrier surround 350 and 355. The barrier surround 350 and 355 again highlights to the user the location of barrier 305 and 330 respectively. Similar to the skier surround 316 and the snowboarder surround 321, the barrier surround 350 and 355 may flash or be formed of bright colours or in some way highlight the barrier 305 and 330 to the user. Of course, it may be that barriers are not included and the piste is defined using coloured poles. These poles may be coloured according to the difficulty of the slope. For example, green poles used on a green slope, red poles used on a red slope and the like.

An information panel 335 is also provided. The information panel 335 may be provided anywhere within the field of view of the user. However, it is desirable for the information panel 335 to be located so as to not obstruct the view of the user. Specifically, in this case, the information panel 335 is located to the top left hand side of the view so as to not overlap with any obstructions. Of course, it is envisaged that the information panel 335 may be located in a stationary position in the view of the user. In order to reduce the possibility of obstructing the view of the user, the information panel 335 may be partially transparent so that the user may see the view behind the information panel 335. It may be desirable to keep the position of the information panel 335 stationary. This ensures that the user can see the information panel 335 at the same location all the time. Indeed, the device 100 may be configured to keep the position of the information panel 335 stationary with respect to the user's view, but to avoid obstructing the user's view, altering the transparency of the information panel 335 so that when located over an obstacle, the information panel 335 becomes transparent.

The information panel 335 includes information such as speed of the user, altitude of the user, direction of the user, heart rate of the user or the like. This information may be retrieved from the sensors 106 described with reference to FIG. 1.

The patch of ice 325 is surrounded by an ice surround 324. The ice surround 324 is typically a bright colour that highlights to the user the existence of a patch of ice.

Moreover, there is provided an arrow 340 marked “DANGER”. This arrow 340 will typically be in a bright colour and will flash or blink. To accompany the arrow 340, an audible alarm will sound through the audio unit 102. The arrow 340 in FIG. 3B is pointing to the right. To accompany this, the audible alarm may also play in the user's right ear. This indicates that a hazard is out of sight of the user but is on the right hand side of the user. This, typically, will be another skier or snowboarder approaching the user from the right hand side. Moreover, as will be explained later, this danger alert may only trigger when the current course of the user and the course of the approaching skier or snowboarder collide. This allows the user to take evasive action to avoid approaching skier or snowboarder.

In order to assist the user, the visual unit 104 provides direction arrow 345. Direction arrow 345 provides the user with a suggested direction to avoid the approaching skier or snowboarder whilst also avoiding the obstacles in the user's current view. In order to quickly assist the user, the colour of the direction arrow 345 may be green. In other words, because the direction arrow 345 is provided in green, the user will quickly know which direction to follow.

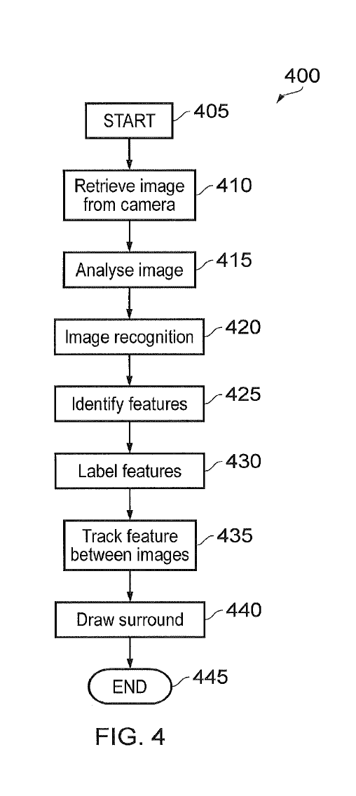

The method by which skier and snowboarder surround and the barrier surround is generated will now be described with reference to FIG. 4. It should be noted that this mechanism 400 is known in the field of augmented reality and so a detailed explanation will not be provided.

The process starts at step 405. An image is then retrieved from the camera in step 410. Specifically, in respect of the skier and snowboarder surround, the image is retrieved from camera 116A. In other words, the ski and snowboarder surround is overlaid on the real life skier or snowboarder viewed by the user. Camera 116A has a field of view similar to that of the user and so in the context of skier and snowboarder surround, the image from camera 116A is analysed.

The retrieved image is analysed in step 415. Specifically, object recognition is performed (step 420) on the image. In this object recognition, the image is analysed to identify skiers, snowboarders, barriers, signs or other features (step 425). These features may be predefined. Although object recognition is in general known, the manner in which it is performed in the disclosure is different to known techniques. To identify a skier, the retrieved image may be first analysed for the presence of one or more ski. Once the ski is identified, the area in the image surrounding the ski may be analysed to identify a person. This person will be deemed the skier. Similarly, for a snowboarder, a snowboard may be first identified. Once the presence of a snowboard is established, the area in the image surrounding the snow board may be analysed to identify a person. This person will be deemed the snowboarder. By identifying a known distinctive shape such as a ski or snowboard in the image first and then performing person recognition in the area surrounding the distinctive shape, the process of skier and snowboarder recognition is computationally efficient. Of course, as an alternative, the object recognition may first identify a person in the captured image. The stance of the person may then be analysed and, as explained above, the person will be determined to be a skier or snowboarder based on their stance. In addition, once the person is identified, the object recognition may identify the presence of a ski or snowboard before the stance is analysed. The stance of the skier or snowboarder may then be analysed to validate the recognition of a skier or a snowboarder.

After a skier or snowboarder is identified, the skier or snowboarder is labeled (step 430) and stored in the storage unit 108. This enables the skier or snowboarder to be tracked between images (step 435). The skier or snowboarder surround will then be drawn around the identified skier or snowboarder in step 440. The process then ends in step 445.

Although image recognition is used on a per frame basis to identify a ski or snowboard and then the skier or snowboarder is then identified, it is possible that the skier or snowboarder may be identified from the image directly. This may be achieved in two new ways. Firstly, in step 420 a person may be identified in the image. The stance of the person may then be analysed to determine whether the person is a skier or snowboarder. Specifically, skiers and snowboarder have different stances from one another. The skier tends to have both feet parallel to one another facing down the mountain. However, a snowboarder faces side on relative to the mountain. These stances are particular to skiing and snowboarding respectively and will also distinguish from people standing or walking on the mountain.

Secondly, as the skier or snowboarder is labeled in one image, the movement of the skier or snowboarder may be analysed between consecutive images. This may be useful because the movement of the skier is different to that of the snowboarder. Therefore, by analysing the movement of the skier or snowboarder between consecutive images, it is possible to determine whether the identified individual is a skier or a snowboarder.

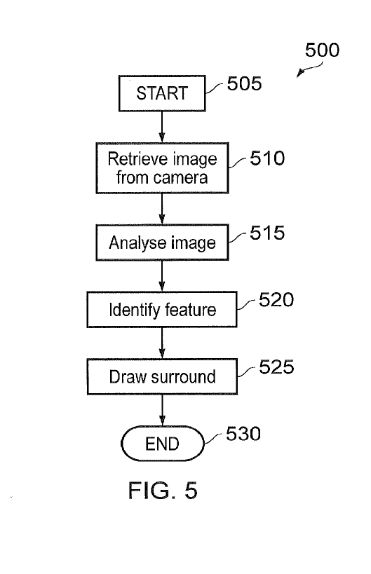

FIG. 5 describes the mechanism 500 using which ice on the slope is detected and the ice surround provided. The process starts at step 505. An image in the direction the user is facing is retrieved in step 510. This may be an image from camera 116A as described with reference to FIG. 4. Alternatively, and/or additionally, a second camera which detects infra-red radiation may be used to detect ice. In other words, camera 116A may capture both visual images and infra-red images. Of course, a further camera (not shown) may be used to capture the infra-red image in the direction the user is facing.

The captured image is analysed in step 515. Specifically, to detect ice from camera 116A the colour and texture of the snow may be analysed. Where the colour of the snow becomes grey rather than white, ice has usually formed. Therefore, the colour of the captured image is analysed; where an area of the image is grey surrounded by white, then ice is determined to be present. This allows the feature of ice to be identified (step 520). The reflectivity of the snow may also be analysed. Snow and ice have different reflectivity values. This can be identified from the image and is another mechanism to detect ice.

The ice surround is then drawn around the identified patch of ice in step 525 and the process ends in step 530.

As noted above, an infra-red camera may be used to replace or supplement the identification of ice on the slope. Specifically, as is known, ice has a different infra-red signature to snow. Therefore, if the infra-red field of view is mapped to the visual unit 104 so that the identified position of the ice using the infra-red camera can be mapped to the user's field of view, then the ice surround may be drawn around the ice patch in step 525.

Additionally, different types of snow may be identified. This may be achieved through infra-red signature or the type of flake contained in the snow. This will allow an obstacle to be identified that has a higher than average risk of causing an avalanche.

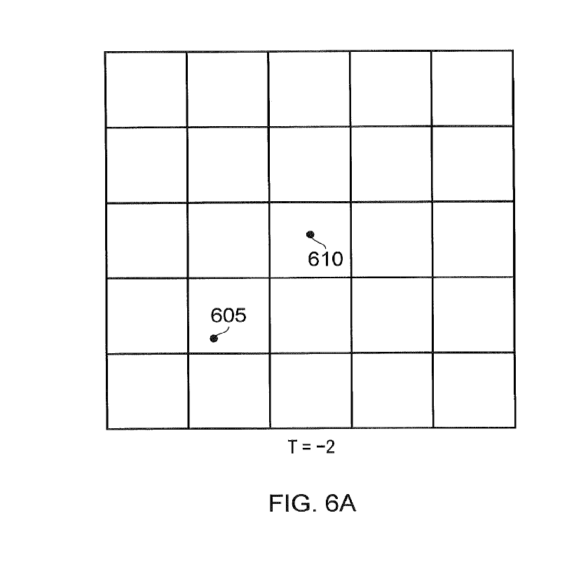

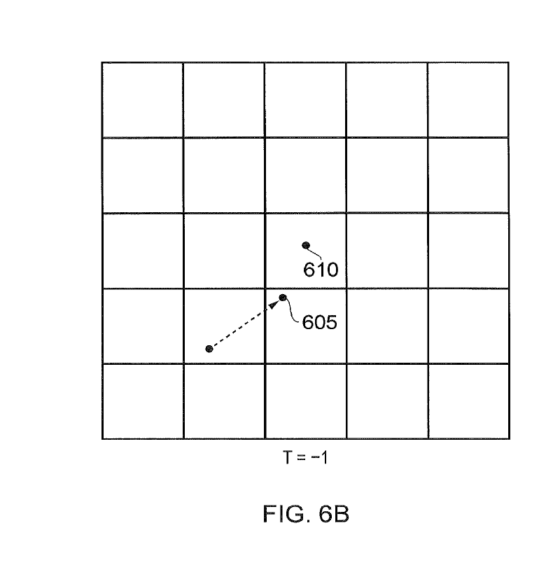

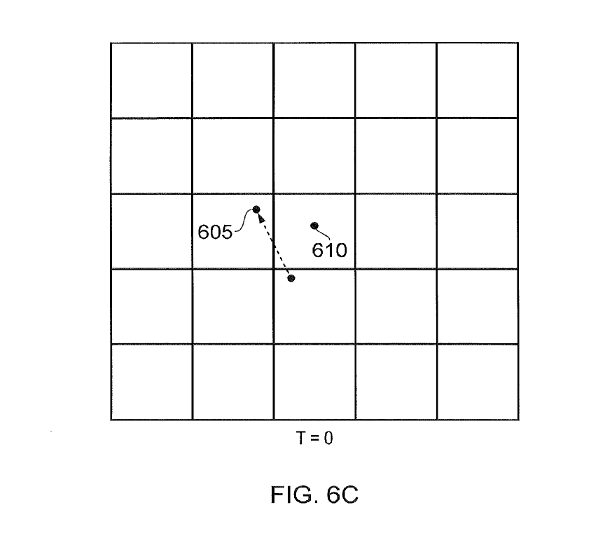

FIG. 6A to FIG. 6C shows the movement of a skier 605 relative to the user 610 at various time intervals. In FIG. 6A, skier 605 is located behind the user 610. This position is at T=−2. In FIG. 6B, skier 605 has moved to a different position at T=−1. The movement of the skier 605 between T=−2 and T=−1 is shown by the dotted line. In FIG. 6C, skier 605 has moved again to a different position at T=0. The movement between T=−1 and T=0 is shown by the dotted line. As can be seen, the skier 605 and the user 610 are not predicted to collide.

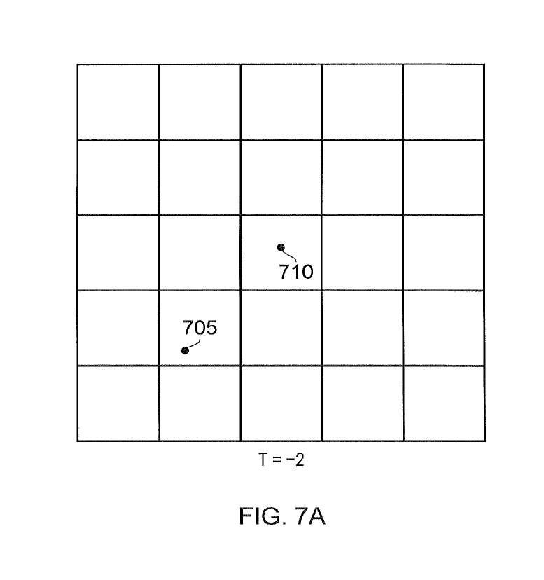

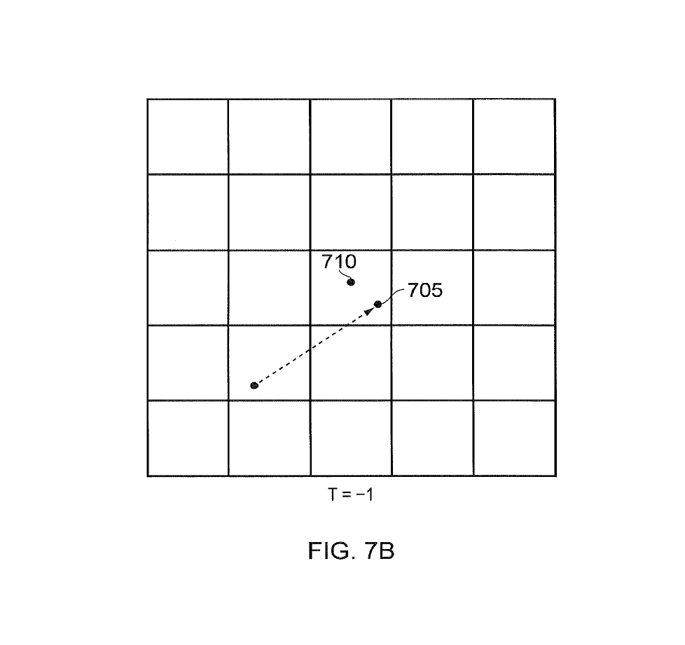

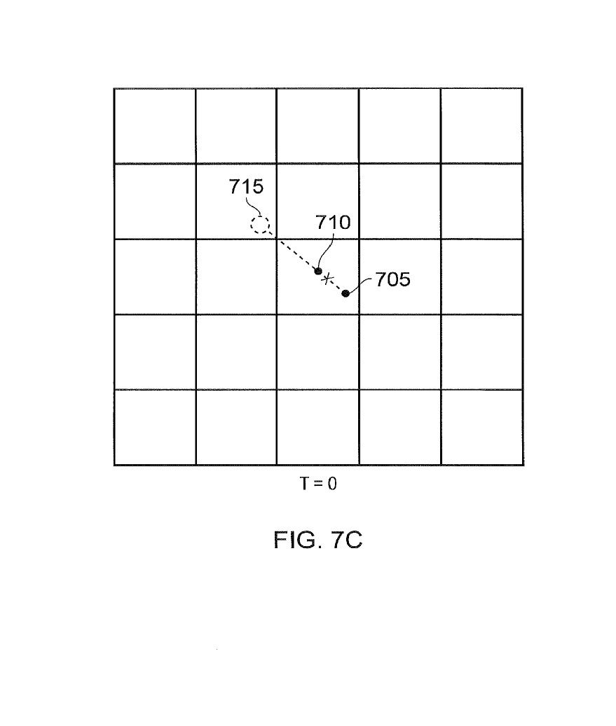

FIG. 7A to FIG. 7C shows the movement of a skier 705 relative to the user 710 at various time intervals. In other words, skier 705 in these Figures may be moving or may be stationary. In FIG. 7A, skier 705 is located behind the user 710. This position is at T=−2. In FIG. 7B, skier 705 has moved to a different position at T=−1. The movement of the skier 705 between T=−2 and T=−1 is shown by the dotted line. In FIG. 7C, skier 705 is predicted to move to position 715. This prediction is based on a number of factors. As a non-exhaustive list, the prediction is based on the fact that the person 705 is a skier. As would be appreciated and as noted above, skiers move in a different way to snowboarders. Therefore, the travel of the person would be that of a skier and so would be expected to move left in the figure. Additionally, it is expected that the motion of the skier 705 would have been analysed for many seconds.

This allows the future motion of the skier 705 to be predicted more accurately. Further, the distance travelled by the skier 705 between image capturing events would be calculated as the speed of the skier and the time between image capturing events would be known. This process will be explained later. Accordingly, it is predicted that given the position of the user 710 relative to the skier 705 will result in a collision (identified by an “X” in FIG. 7C). The skier 705 will collide with the user 710 on the user's right hand side.

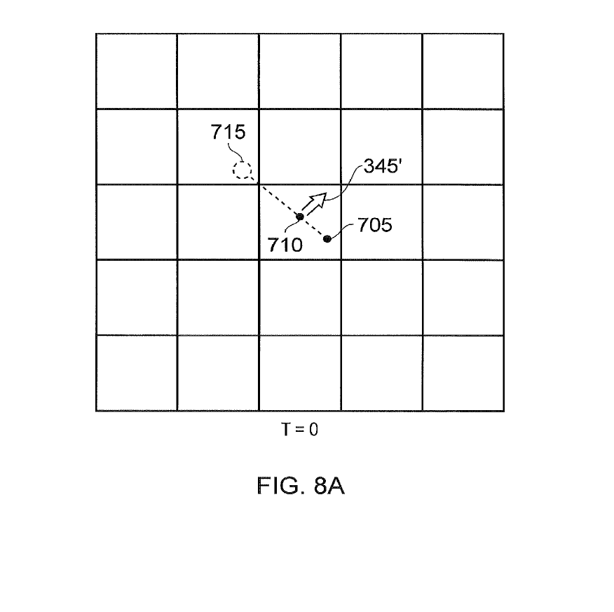

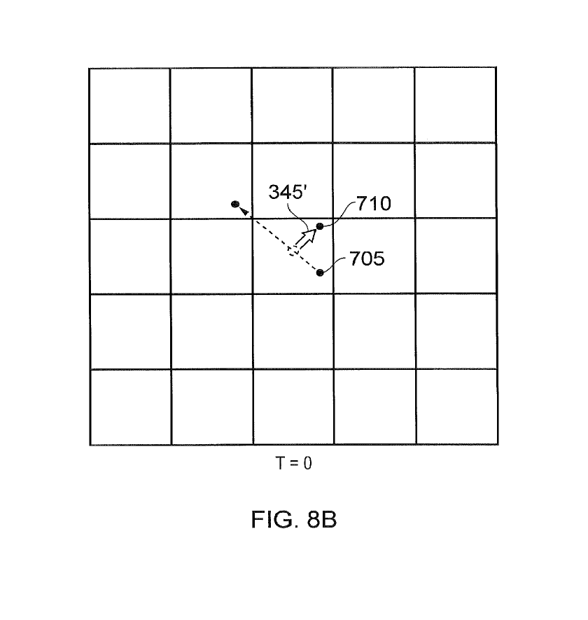

In embodiments of the present disclosure, as indicated in FIG. 3B, the user is notified of this with symbol 340 being presented to the user. As a consequence, the direction arrow 345 is then presented to the user to indicate a direction in which the user should travel to avoid the collision. This is identified on FIG. 8A, where the direction arrow is signified by numeral 345′. In FIG. 8B the user 710 is shown to have moved in the direction of arrow 345′ and thus skier 705 avoids a collision with user 710.

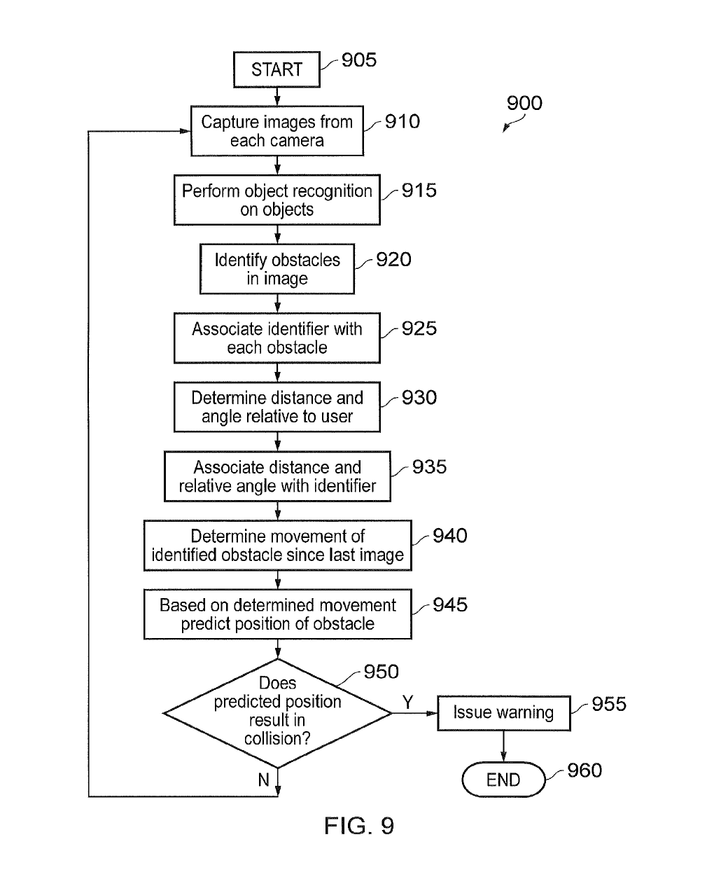

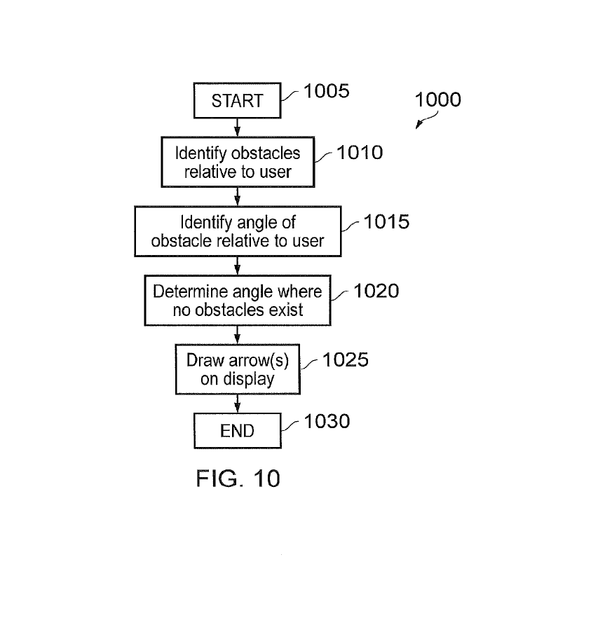

The mechanism for determining the warning and the generation of the direction arrow 345 will now be described with reference to the flow charts shown in FIGS. 9 and 10.

Referring to FIG. 9, a process to determine the warning 900 is shown. The process starts at step 905. In this process, an image is captured at each of the four cameras 116A-116D. This is step 910. The image processing described in the remainder of the description will explain the process in respect of a single image. However, it will be appreciated that the process will be applied to the images captured by each of the cameras 116A-116D.

In each image, object recognition is performed in step 915. The objects to be recognised are skiers and snowboarders. As noted above, these may be recognised by firstly identifying skis and/or snowboards in the image. Alternatively or additionally, the person on either the skis or snowboard will have a characteristic stance. However, in embodiments, other obstacles may be recognised. For example, as identified in FIG. 3B, barriers signifying the edge of the piste may be recognised. These typically have a characteristic colour and shape. Further, obstacles such as patches of ice can be recognised as noted above. Moreover, other obstacles such as trees, sharp changes in gradient of the slope, rocks and the like can also be recognised. Each of these recognised obstacles are identified in step 920.

An identifier is associated with each recognised obstacle in step 925. In particular, each new recognised obstacle has an identifier associated with it. The identifier allows the obstacle to be uniquely identified. Therefore, the identifier may be generated in accordance with a time stamp or may be a simple iteration from the previous identifier.

The distance and angle from the camera capturing the image to the obstacle is determined in step 930. This may be achieved using any appropriate technique. For example, the camera 116A may have a range finder incorporated. Alternatively, the distance may be approximated from the image alone using known techniques.

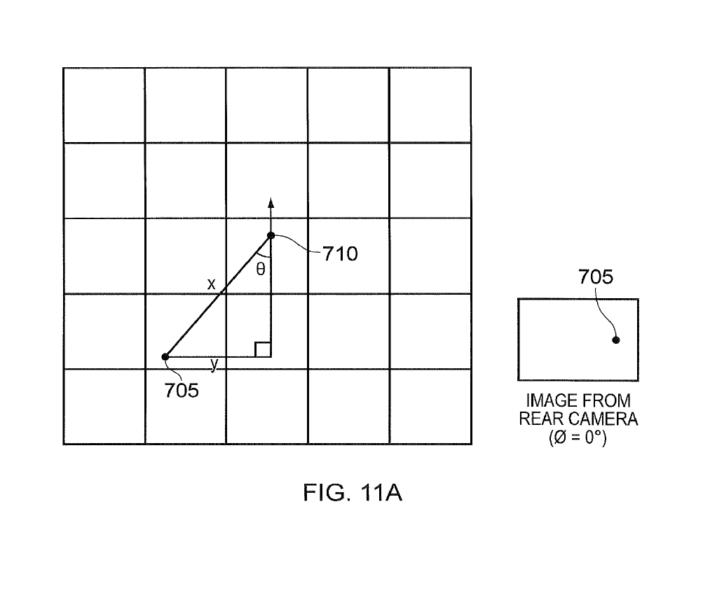

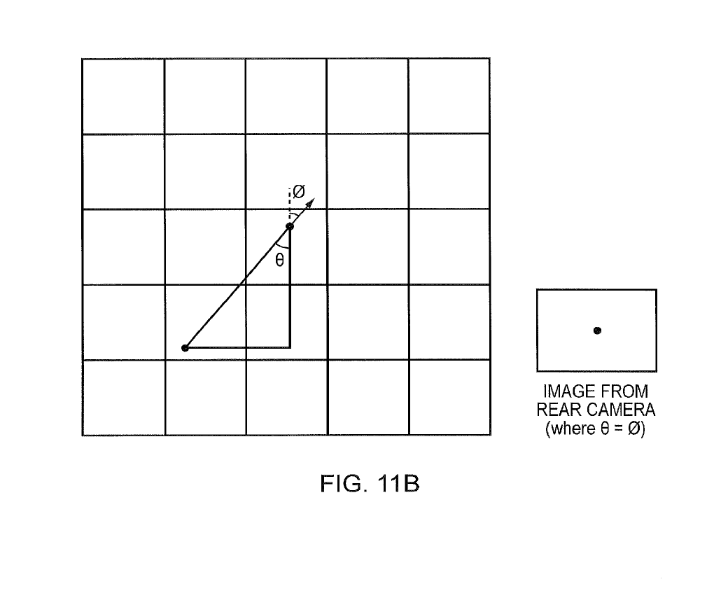

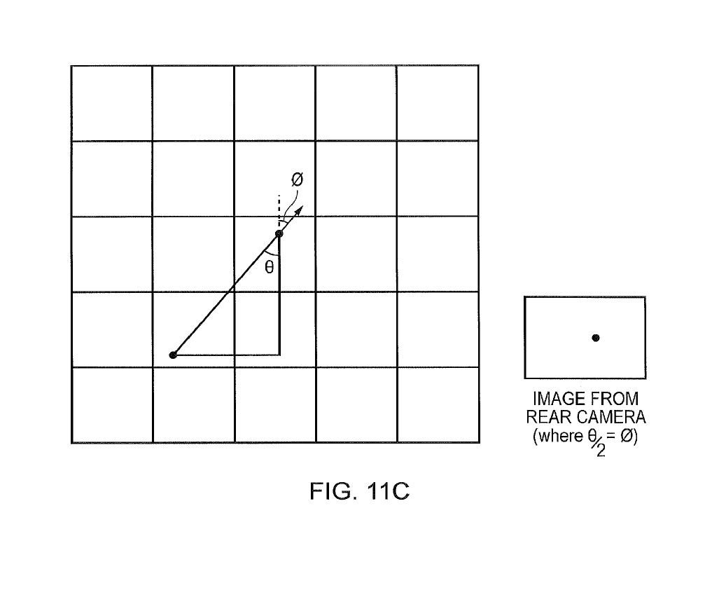

The angle relative to the user is also determined. This process is explained with reference to FIGS. 11A-11C. Referring to FIG. 11A, user 710 and skier 705 is shown. The grid shows an overhead view of the skier 705 and the user 710 and to the right of the Figure is shown the image captured by the rear facing camera 116C. The angle φ is the angle the user is facing relative to straight ahead. So, in FIG. 11A, as the user is facing straight ahead, φ=0°.

The physical distance between the user 710 and the skier 705 (x as shown in FIG. 11A) is determined. Additionally, the physical horizontal distance from the optical axis of the camera and the skier 705 is determined. This may be achieved by having a reference physical distance being equated to a reference pixel separation at the camera focal length. Therefore, by knowing the number of horizontal pixels the skier 705 is from the optical axis, the value of y can be determined.

In particular, if x is the physical distance from the camera and y is the physical distance from the optical axis of the camera, then the angle θ=(sin⁻¹ (y/x)) [Equation 1].

However, the angle the user is facing has an impact on the captured image. This is shown in FIG. 11B where φ=θ. As can be seen in this Figure, the image captured by the rear facing camera 116C shows the skier 705 on the optical axis of the image.

Similarly, in FIG. 11C, the angle of φ=θ/2. Therefore, the skier 705 appears to be located mid-way between FIG. 11A and 11B.

In fact, to account for the direction the user faces, the angle relative to the user, θ_{FINAL}=θ+φ. From Equation 1 above, θ_{FINAL}=(sin⁻¹ (y/x))+φ.

As the skilled person will understand, the value of φ can be determined using an accelerometer (which is a sensor 106).

Returning to FIG. 9, the calculated distance and angle is stored in association with the identifier in step 935.

The amount of movement of the identified obstacle between the last captured image and the presently captured image is then determined in step 940. This determined movement is then used in step 945 to predict the position of the skier 705 in the next captured image. In other words, the process assumes that the movement of the skier between consecutive images is the same. Of course, this is only one mechanism in which the position of the skier in the next image can be predicted. Other mechanisms include reviewing the last 10 or 20 frames and determining the position based on the movement over a longer period. Another example is to determine when the skier last changed direction and to determine how many frames the skier skis between turns. From that, it is possible to determine when the skier will change direction. As will be appreciated, the prediction can be changed depending on the type of obstacle (whether the obstacle is a skier or snowboarder) or whether the obstacle is stationary or dynamic.

Given the relative position between the user and the obstacle (in this case skier 705), if the predicted position of the skier 705 means that the relative distance is zero (or at least under a threshold distance from the user), a collision will be predicted. In other words, in step 950, the “yes” path is followed. In this instance, a warning will be issued in step 955. The warning is similar to that shown as numeral 340 in FIG. 3B. The process ends in step 960.

In the event that no collision is predicted, the no path is followed and the next image is captured from the cameras in step 910. The process is repeated.

The process for identifying a safe route to the user is shown in FIG. 10. The process 1000 starts at step 1005. The process may be run continually so that a safe passage may be continually displayed to the user. Alternatively, the process may be only run when a collision is predicted according to the disclosure of FIG. 9.

An image is captured and the obstacles are identified in step 1010. The obstacles are identified as explained in FIG. 9. Similarly, the angle of the obstacle relative to the user is also determined. This is also explained in FIG. 9 and is step 1015.

As the angle of all obstacles relative to the user is known, the angles of areas with no obstacles are known. This is step 1020. The processing unit 110 then selects the angle having the largest range of no obstacle and that is in front of the user and draws an appropriate arrow on the visual unit 104. This is step 1025. It is envisaged that a number of appropriate paths may be determined. In this case, the processing unit 110 may prioritise the displaying of arrows to display the most appropriate path with the largest arrow, with the least appropriate path having the smallest arrow. Alternatively, only the most appropriate path may be displayed. These priorities may be user defined or predefined.

Several factors may be used to prioritise the paths. Firstly, the largest angle range having no obstacles may be considered the most appropriate path with the least angle range (albeit above a threshold range) being the least appropriate path. Secondly, the path with the shallowest slope may be the most appropriate path. Alternatively, for thrill-seekers, the path with the steepest slope may be the most appropriate path. The priority list may be user defined.

As the selection of the path may be prioritised depending on user selection, the provision of the direction arrow allows the user to more safely traverse the mountain whilst not reducing the enjoyment of the sport.

The process ends at step 1030.

Of course, although the above describes the generation of an appropriate path, if the system identifies that no appropriate path may be chosen, the system may indicate to the user that a crash is imminent and to prepare for a crash. This may be achieved by applying a red border around the screen.

Additionally, although not specifically mentioned in FIG. 10, the appropriate path may also be updated based on a change in obstacle speed, position or direction of travel relative to the skier 705. In other words, if the obstacle suddenly increases speed, the appropriate path may be changed based on this increase.

It is envisaged that the processing unit 110 will run the described processes.

Although the above describes the device as operating independently of other skiers, the device is not so limited. Specifically, a number of devices may be connected together either via Bluetooth or via a local area network on the slope. In this case, the position of each skier or snowboarder may be identified using GPS and communicated to the other skiers or snowboarders in the vicinity. In this case, there would be no need to identify the obstacles from the image. Moreover, in the case that the device 100 identifies a stationary obstruction, such as a barrier, then the absolute position of the stationary obstruction, such as its GPS co-ordinates, may be provided to other users. This again would allow the stationary obstructions to be identified without reference to an image.

Embodiments of the present disclosure may in general be defined by the following numbered paragraphs.

1. A snow-sport head mounted display device for a user, the display device comprising: an augmented reality display and processing circuitry configured to provide augmented reality information to the augmented reality display, wherein the processing circuitry is configured to receive an image of the real-world, identify at least one real-world obstacle in the image, and display, on the augmented reality display, an appropriate path for travel on the basis of the at least one identified obstacles.
2. A display device according to paragraph 1, wherein the image is taken from a 360° view of the real-world.
3. A display device according to paragraph 1 or 2, wherein the processing circuitry is configured to determine the relative angle between the identified obstacles and the user, wherein the appropriate path is based on the determined relative angle.
4. A display device according to any preceding paragraph, wherein the processing circuitry is configured to determine the relative angle and distance between the identified obstacles and the user and to display a warning to the user in the event that the relative angle and the distance indicate a collision between the obstacle and the user.
5. A display device according to paragraph 4, comprising an audio unit for coupling to a speaker wherein the processing circuitry is configured to control the audio unit to produce an audible warning to the user in the event that the relative angle and the distance indicate a collision between the obstacle and the user.
6. A display device according to any preceding paragraph, wherein the processing unit is configured to identify either a ski or snowboard from the image and to identify the obstacle as a skier or snowboarder on the basis of the identified ski or snowboard respectively.
7. A display device according to any preceding paragraph, wherein the processing unit is configured to identify either a skier or snowboarder as a real-world obstacle on the basis of the stance of the skier or snowboarder.
8. A display device according to any preceding paragraph, wherein the processing unit is configured to identify an ice patch as the obstacle.
9. A method of augmented reality display for a snow-sport user comprising: receiving an image of the real-world, identifying at least one real-world obstacle in the image, and displaying, on an augmented reality display to the user, an appropriate path for travel on the basis of the at least one identified obstacles.
10. A method according to paragraph 9, wherein the image is taken from a 360° view of the real-world.
11. A method according to paragraph 9 or 10, comprising determining the relative angle between the identified obstacles and the user, wherein the appropriate path is based on the determined relative angle.
12. A method according to any one of paragraph 9 to 11, comprising determining the relative angle and distance between the identified obstacles and the user and displaying a warning to the user in the event that the relative angle and the distance indicate a collision between the obstacle and the user.
13. A method according to paragraph 12, comprising producing an audible warning to the user in the event that the relative angle and the distance indicate a collision between the obstacle and the user.
14. A method according to any one of paragraph 9 to 13, comprising identifying either a ski or snowboard from the image and identifying the obstacle as a skier or snowboarder on the basis of the identified ski or snowboard respectively.
15. A method according to any one of paragraph 9 to 14, comprising identifying either a skier or snowboarder as a real-world obstacle on the basis of the stance of the skier or snowboarder.
16. A method according to any one of paragraph 9 to 15, comprising identifying an ice patch as the obstacle.
17. A computer program product comprising computer readable instructions which, when loaded onto a computer, configure the computer to perform a method according to any one of paragraph 9 to 16.
18. A device, method or computer program product as substantially hereinbefore described with reference to the accompanying Figures.

1. A snow-sport head mounted display device for a user, the display device comprising: an augmented reality display and processing circuitry configured to provide augmented reality information to the augmented reality display, wherein the processing circuitry is configured to receive an image of the real-world, identify at least one real-world obstacle in the image, and display, on the augmented reality display, an appropriate path for travel on the basis of the at least one identified obstacles.

2. The display device according to claim 1, wherein the image is taken from a 360° view of the real-world.

3. The display device according to claim 1, wherein the processing circuitry is configured to determine the relative angle between the identified obstacles and the user, wherein the appropriate path is based on the determined relative angle.

4. The display device according to claim 1, wherein the processing circuitry is configured to determine the relative angle and distance between the identified obstacles and the user and to display a warning to the user in the event that the relative angle and the distance indicate a collision between the obstacle and the user.

5. A display device according to claim 4, comprising an audio unit for coupling to a speaker wherein the processing circuitry is configured to control the audio unit to produce an audible warning to the user in the event that the relative angle and the distance indicate a collision between the obstacle and the user.

6. The display device according to claim 1, wherein the processing unit is configured to identify either a ski or snowboard from the image and to identify the obstacle as a skier or snowboarder on the basis of the identified ski or snowboard respectively.

7. The display device according to claim 1, wherein the processing unit is configured to identify either a skier or snowboarder as a real-world obstacle on the basis of the stance of the skier or snowboarder.

8. The display device according to claim 1, wherein the processing unit is configured to identify an ice patch as the obstacle.

9. A method of augmented reality display for a snow-sport user comprising: receiving an image of the real-world, identifying at least one real-world obstacle in the image, and displaying, on an augmented reality display to the user, an appropriate path for travel on the basis of the at least one identified obstacles.

10. The method according to claim 9, wherein the image is taken from a 360° view of the real-world.

11. The method according to claim 9, comprising determining the relative angle between the identified obstacles and the user, wherein the appropriate path is based on the determined relative angle.

12. The method according to claim 9, comprising determining the relative angle and distance between the identified obstacles and the user and displaying a warning to the user in the event that the relative angle and the distance indicate a collision between the obstacle and the user.

13. The method according to claim 12, comprising producing an audible warning to the user in the event that the relative angle and the distance indicate a collision between the obstacle and the user.

14. The method according to claim 9, comprising identifying either a ski or snowboard from the image and identifying the obstacle as a skier or snowboarder on the basis of the identified ski or snowboard respectively.

15. The method according to claim 9, comprising identifying either a skier or snowboarder as a real-world obstacle on the basis of the stance of the skier or snowboarder.

16. The method according to claim 9, comprising identifying an ice patch as the obstacle.

17. A computer program product comprising computer readable instructions which, when loaded onto a computer, configure the computer to perform a method according to claim 9.
